(19) United States
(12) Patent Application Publication
(10) Pub. No.: US 2017/0308689 A1
(43) Pub. Date: Oct. 26, 2017

(54) Gesture-based Wireless Toggle Control System and Method

(71) Applicant: BRAGI GmbH, München (DE)

(72) Inventor: Peter Vincent Boesen, München (DE)

(21) Appl. No.: 15/489,018

(22) Filed: Apr. 17, 2017

Related U.S. Application Data
(60) Provisional application No. 62/327,916, filed on Apr. 26, 2016.

(51) Int. Cl. G06F 21/32; G10L 17/22; G06F 3/01; H04R 1/10; H04W 12/06

(52) U.S. Cl. CPC G06F 21/32; H04W 12/06; H04R 1/1041; G06F 3/012; H04R 1/1016; G10L 17/22; H04R 2420/07

(57) ABSTRACT

A system, wireless earpiece, and method for communicating with a vehicle system. A vehicle system is associated with one or more wireless earpieces. A determination is made whether a user is authorized to communicate with the vehicle system utilizing the one or more wireless earpieces. User input is received to activate communications with the vehicle system through the one or more wireless earpieces. Communications are enabled between the one or more wireless earpieces and the vehicle system. Communications are sent and received between the one or more wireless earpieces and the vehicle system.

### PRIORITY STATEMENT

This application claims priority to U.S. Provisional Patent Application 62/327,916, filed on Apr. 26, 2016, and entitled Gesture-based Wireless Toggle Control System and Method, hereby incorporated by reference in its entirety.

### BACKGROUND

### I. Field of the Disclosure

The illustrative embodiments relate to wireless earpieces. More specifically, but not exclusively, the illustrative embodiments relate to communications through a vehicle systems utilizing one or more wireless earpieces.

### II. Description of the Art

The growth of wireless devices including wearable wireless devices is increasing exponentially. This growth is fostered by the decreasing size of transceivers, chips, and other components as well as enhanced computing and communications standards and protocols. At the same time, vehicle communication systems have become increasingly sophisticated. In some cases, ensuring privacy and effective communications while communicating in a vehicle with multiple people aboard may be difficult based on the common usage of speakerphones and open microphones.

### SUMMARY OF THE DISCLOSURE

One aspect provides a system, wireless earpiece, and method for communicating with a vehicle system. A vehicle system is associated with one or more wireless earpieces. A determination is made whether a user is authorized to communicate with the vehicle system utilizing the one or more wireless earpieces. User input is received to activate communications with the vehicle system through the one or more wireless earpieces. Communications are enabled between the one or more wireless earpieces and the vehicle system. Communications are sent and received between the one or more wireless earpieces and the vehicle system. Another embodiment provides a wireless earpieces including a processor and a memory storing a set of instructions. The set of instructions are executed to perform the method described.

Yet another aspect provides a wireless earpiece. The wireless earpiece includes frame for fittings in an ear of a user. The wireless earpiece further includes a logic engine controlling functionality of the wireless earpiece. The wireless earpiece further includes a number of sensors that perform biometric readings of the user and receiving user inputs. The logic engine associates a vehicle system with the wireless earpiece, determines whether a user is authorized to communicate with the vehicle system utilizing the wireless earpiece, receives user input to activate communications with the vehicle system through the wireless earpiece, enables communications between the wireless earpiece and the vehicle system, sends and receives the communications between the wireless earpiece and the vehicle system utilizing a transceiver in communication with the logic.

### BRIEF DESCRIPTION OF THE DRAWINGS

Illustrated embodiments are described in detail below with reference to the attached drawing figures, which are incorporated by reference herein, and where:

FIG. 1 is a pictorial representation of a communications system in accordance with an illustrative embodiment:

FIG. 2 is a block diagram of wireless earpieces and a vehicle system in accordance with an illustrative embodiment;

FIG. 3 is a flowchart of a process for performing communications with a vehicle system utilizing wireless earpieces in accordance with an illustrative embodiment; and

FIG. 4 depicts a computing system in accordance with an illustrative embodiment.

### DETAILED DESCRIPTION OF THE DISCLOSURE

The illustrative embodiments provide a system, method, and wireless earpieces for enhancing vehicle communications. it is to be understood that features of the various embodiments may be combined. In one embodiment, a gesture-based wireless toggle control system may be utilized to activate communications between the wireless earpieces and the vehicle system. The wireless earpieces are worn in the ears of the user. The utilization of the wireless earpieces with the vehicle system stay ensure enhanced privacy when communicating in a vehicle with passengers. The communications may represent bi-directional or two-way communications or unidirectional communications.

The wireless earpieces may work in combination with the vehicle systems, or one or more wireless devices to store applicable data and information, such as identifiers, descriptions, commands, functionality, and so forth. Authorization to communicate with and control the vehicle system may be based on one or more passwords, secure identifiers, biometrics, or so forth that may be stored or accessed by the wireless earpieces.

In one embodiment, the wireless earpieces may work in combination with a dynamic or static wireless device, such as a cell phone, smart card, smart wearable (e.g., watch, ring, etc.), or so forth. The communications may be performed by a pair of wireless earpieces or a single wireless earpiece worn by the user. The description included herein may refer to the wireless earpieces individual or collectively.

The wireless earpieces represent a smart wearable device that may be worn within the ears of the user. As with all personal devices, the wireless earpieces may store valuable personal information including name, address, age, sex, user preferences, user biometrics, user financial information for implementing transactions (e.g., debit/credit card numbers, account numbers, user names, passwords, pins, etc.), location information, and other sensitive personal information. The wireless earpieces include a number of sensors that may be configured to read biometric and environmental information associated with the user. The wireless earpieces may also receive user input from the user including gestures, voice commands, motions, taps, swipes, or other forms of feedback. The biometric information may include heart rate or pattern, fingerprints, mapping of the user's ear/head, voice analysis, skin conductivity, height determinations, and so forth. The biometric readings or information ma also be stored for any number of purposes including health monitoring, identification, tracking, and so forth.

The wireless earpieces may also provide additional information determined, such as length of time in the current location, movement characteristics (e.g., heading, speed, path, etc.), most recent time of movement, motion relative to other vehicles, user provided description of the location, and other relevant information. The illustrative embodiments provide additional security within a vehicle because the use of a screen or display is not required. For example, the information may be communicated directly to the user audibly providing enhanced privacy. The user may specify that only authorized or otherwise specified users of the wireless earpieces are allowed to communicate with the vehicle system. For example, identifying biometric information and/or user input may be required to identify and authenticate the user. The wireless earpieces may also send communications to the vehicle system directly or indirectly (e.g., networks, connection through a wireless device, etc.).

The illustrative embodiments may allow a user to loan the wireless earpieces to another user without concern for breaching or contamination of their own unique personal biometric data, vehicle access, or improper usage of the wireless earpieces. In one embodiment, the primary or administrative user may establish profiles for any number of users that may utilize a single set of wireless earpieces. For example, the primary user may control the user profiles of the secondary users that allows or prevents them from communicating with or controlling the vehicle. As a result, any number of users may be able to control and manage access to different vehicle data, functions, and so forth available through the wireless earpieces.

The wireless earpieces are configured to fit at least partially into an external auditory canal of the user. The ear canal is a rich space for obtaining biometric measurements about the user as well as stabilizing the wireless earpieces as they are worn. The wireless earpieces may be utilized during a number of rigorous physical activities that require stability. The shape and configuration of the wireless earpieces allow the wireless earpieces to be worn for long periods of time while gathering valuable information utilizing the sensors of the wireless earpieces. The wireless earpieces may include sensors for measuring pule rate, blood oxygenation, microphone, position/orientation, location, temperature, altitude, cadence, calorie expenditure, and so forth.

The wireless earpieces may include any number of sensor ways configured to capture information about the user. The large amount of data may be utilized to authenticate the user for any number of requests, such as communicating with a vehicle. The wireless earpieces may configure themselves to perform various functions as well as sending commands to any number of proximate devices to implement actions, commands, or requests, or transactions. The wireless earpieces may learn over time in response to selections made utilizing the wireless earpieces or interconnected devices, such as a cell phone. The sensors may sense dynamic manifestations including movement patterns, fluidity, hesitations, volume of the voice, amplitude and frequency modulations (e.g., jitter, shimmer rates, etc.) temperature fluctuations, increases or decreases in heart rate, and level of sweat production for comparison utilizing logic of the wireless earpieces to generate one or more actions. Alerts may be played to the user indicating the status of communications with a vehicle, status of the vehicle or subsystems, and any other applicable information relating to the user, vehicle, wireless earpieces, or so forth.

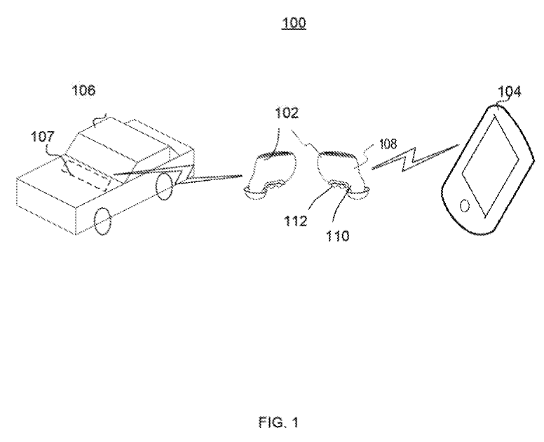

FIG. 1 is a pictorial representation of a communication system 100 in accordance with an illustrative embodiment. In one embodiment, the communication system 100 may include wireless earpieces 102, a wireless device 104, vehicle 106, and vehicle systems 108. The components of the communication system 100 may be utilized within the vehicle 106 by a driver, passengers, or combination of both (hereinafter a “user”). The vehicle 106 is shown as a car. However, in other embodiments, the vehicle 106 may represent a motorcycle, plane, bus, train, boat, facility, or vehicle.

The wireless earpieces 102 and the wireless device 104 may represent personal electronic devices of a user. For example, the wireless earpieces 102 may be worn in the ears of the user. The wireless device 104 may be utilized or carried by the user. Communications within the communication system 100 may occur directly or indirectly between the various components of the communication system 100, such as the wireless earpieces 102, the wireless device 104, and the vehicle system 108.

The vehicle system 108 may include any number of entertainment, navigational, control, and communication systems. For example, the vehicle system 108 may enable the user to watch or listen to content (e.g., music, digital movies, podcasts, books on tape, DVDs, etc.), navigate from one place to another utilizing global positioning information retrieved directly by the vehicle system 108 or the wireless device 104, control vehicle systems and performance (e.g., steering, suspension, windows, wipers, heat and cooling systems, door controls, etc.), or manage any number of other systems, subsystems, features, or functions.

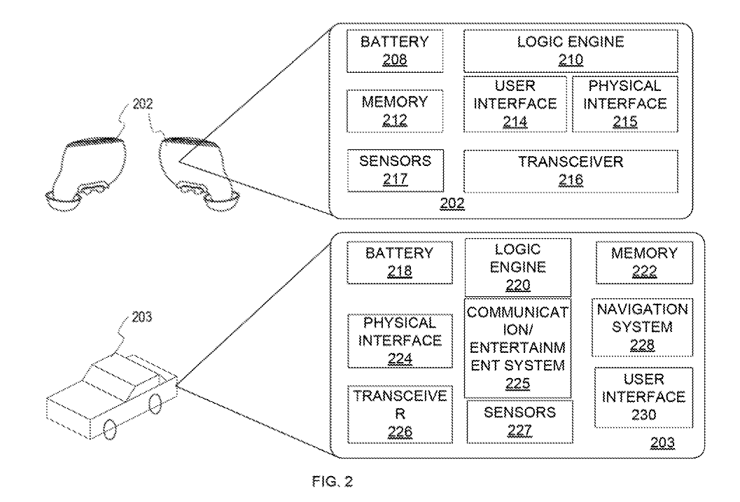

The illustrative embodiments allow the functionality, features, and sensors of the wireless earpieces 102 to enhance communications within the vehicle 106. For example, audio communications within the vehicle 106 may occur directly through the wireless earpieces 102 with the ears of the user rather than through the speakers or other interfaces of the vehicle systems 108. As a result, the security and privacy of the user and/or communications within the vehicle 106 are protected, authorized, and secured. As noted, the wireless earpieces 102 may be worn by a user (not shown) and are shown both as worn and separately from their positioning within the ears of the user for purposes of visualization. A block diagram of the wireless earpieces 102 and vehicle system 108 are further shown in FIG. 2 to further illustrate components and operation of the wireless earpieces 102.

In one embodiment, the wireless earpieces 102 include a frame 108 shaped to fit substantially within the ears of the user. The frame 108 is a support structure that at least partially encloses and houses the electronic components of the wireless earpieces 102. The frame 108 may be composed of a single structure or multiple structures that are interconnected. The frame 108 defines an extension 110 configured to fit substantially within the ear of the user. The extension 110 may house one or more speakers, ear-bone microphones, or vibration components for interacting with the user. The extension 110 may be removable covered by one or more sleeves. The sleeves may be changed to fit the size and shape of the user's ears. For example, the sleeves may fit over an innermost portion of the extension 110 to fit the year of the user while maximizing comfort and delivery of audio to the user. The sleeves may come in various sizes and have extremely tight tolerances to fit the user and one or more other users that may utilize the wireless earpieces 102 during their expected lifecycle. In another embodiment, the sleeves may be custom built to support the interference fit utilized by the wireless earpieces 102 while also being comfortable while worn.

In one embodiment, the frame 108 or the extension 110 (or other portions of the wireless earpieces 102) may include sensors 112 for sensing pulse, blood oxygenation, temperature, voice characteristics, skin conduction, glucose levels, impacts, activity level, position, location, orientation, as well as any number of internal or external user biometrics. A first set of the sensors 112 may represent external sensors that may sense user gestures, contact, motions, fingerprints, and external conditions (e.g., temperature, humidity, pressure, etc.). A number of the sensors 112 may also be internally positioned within the wireless earpieces 102. For example, the sensors 112 may represent metallic contacts, optical interfaces, thermometers, or micro-delivery systems for receiving and delivering information. Small electrical charges may be sensed within the ear of the user as well as passed through the sensors 112 to analyze the biometrics of the user including pulse, skin conductivity, temperature, blood analysis, sweat levels, and so forth. Sensors 112 may also be utilized to provide a small electrical current which may be useful for alerting the user, stimulating blood flow, alleviating nausea, or so forth.

In some applications, temporary adhesives or securing mechanisms (e.g., clamps, straps, lanyards, extenders, chargers, portable battery packs, etc.) may be utilized to ensure that the wireless earpieces 102 remain in the ears of the user even during the most rigorous and physical activities or driving conditions. In one embodiment, the wireless earpieces 102 may be directly connected to the vehicle 106. For example, the wireless earpieces 102 may be utilized during marathons, swimming, team sports, biking, hiking, parachuting, or so forth. The wireless earpieces 102 may be configured to play music or audio, receive and make phone calls or other communications, determine ambient environmental conditions (e.g., temperature, altitude, location, speed, heading, etc,), read user biometrics (e.g., heart rate, motion, temperature, sleep, blood oxygenation, voice output, calories burned, forces experienced, etc.), and receive user input, feedback, or instructions. The wireless device 104 or the wireless earpieces 102 may communicate directly or indirectly with one or more wired or wireless networks, such as a network 120. The wireless earpieces 102 may include logic for dynamically configuring components of the wireless earpieces 102, such as speakers and microphones, to the conditions of the communication system 100.

The wireless earpieces 102 may determine their position with respect to each outer as well as one or more wireless devices (e.g., cell phones) and the vehicle systems 108. For example, position information for the wireless earpieces 102, the vehicle 106, and the wireless device 104 may determine proximity of the devices in the communication system 100. The vehicle systems 108 may determine position and location of the vehicle 106 utilizing global positioning information, wireless triangulation, or signal strength/activity. Similar components or processes may be utilized to determine proximity and distance of the devices to each other in the communication system 100 as well as individual location information.

In one embodiment, the directions, information, or commands from the vehicle systems 108 may be provided audibly to the user (e.g., go straight three blocks and then turn left/west and proceed 3 miles, cruise control has been turned off, you have two passengers not in seatbelts, your DVD entertainment system has been activated, etc.). Audio received from the vehicle systems 108 may be actively filtered to prevent communication through the wireless earpieces 102, such as during an active phone call. The information from the vehicle systems 108 may also be provided through the wireless earpieces 102 or and associated wireless device utilizing an application, or specific interface. Information from the vehicle systems 108, such as directions may also be provided tactilely (e.g., one vibration—straight, two vibrations—right, three vibrations left, four vibrations backwards, etc.).

In one embodiment, the wireless earpieces 102 and the corresponding sensors 112 (whether internal or external) may be configured to take a number of measurements or log information during normal usage. The sensor measurements may be utilized to extrapolate other measurements, factors, or conditions applicable to the user. For example, the sensors 112 may monitor the user's heartbeat or EEG to determine the user's unique pattern or characteristics. The user or another party may configure the wireless earpieces 102 and the vehicle systems 108 directly or through a connected device and application (e.g., mobile app with a graphical user interface) to store or share location or identification information, audio, images, and other data. For example, the user may specify a command, gesture, motion, or other input utilized to perform communications through the wireless earpieces 102.

Some examples of standard usage of the wireless earpieces 102 may include detecting and recording a heartbeat, setting a biometric information for identification of a user and communicating with the vehicle systems 108, setting noise thresholds and the associated speaker volume level or microphone sensitivity, setting a user specified gesture/input for performing an action (e.g., transferring a phone call to the wireless earpieces from the speaker system of the vehicle systems 108, playing music, opening an application, providing an audio indication of biometric feedback, etc.), active initiation or participation in a conversation, listening to music, or so forth. A combination, sequence, or concurrent receipt of biometrics and user input may be associated with the vehicle systems 108 to ensure secure access. Thus, access to various vehicles or vehicle systems as well as the associated features, functions, and data may be secured and protected utilizing unique identifiers. Distinct user profiles and preferences may be utilized to ensure that multiple users may utilize the wireless earpieces 102 with data, functionality, and access for each user and vehicle being completely secured.

In one embodiment, each of the sensors 112 of the wireless earpieces 102 may perform baseline readings to determine which user is utilizing the wireless earpieces 102 and to adapt to the communications system 100 that may be quiet, slightly noisy, loud, or anything in between. For example, the wireless earpieces 102 may determine which of a number of users associated with the wireless earpieces 102 or a guest is utilizing the wireless earpieces 102 and the conditions, parameters, and factors of the applicable communications system 100 which may include any number of environments (e.g., the user's home, train station, work out areas, office environment, mechanical shop, sports venue, etc.). In one embodiment, the wireless earpieces 102 may determine vehicles, vehicle systems, vehicle subsystems, wireless devices, data, functions, and features that may be accessed based on the user, the user's authorization level, location, activity, and so forth. The components of the wireless earpieces 102, such as the speakers and microphones may then be self-adjusted based on the identified user and information associated with the communications environment 100. For example, a younger user may not be authorized to utilize the entertainment systems of the vehicle 106 (within the vehicle systems 108) based on settings specified by a parent/administrator. Location, orientation, and proximity of the vehicle 106, user, and wireless earpieces 102 may be utilized for any number of purposes within the communication system 100 and may be determined differently indoors (e.g., wireless triangulation, signal strength measurements, etc.) as compared to outdoors (e.g., global positioning information, proximity data, mesh networks, etc.).

The wireless earpieces 102 may include any number of sensors 112 and logic for measuring and determining user biometrics, such as pulse rate, skin conduction, blood oxygenation, temperature, calories expended, voice and audio output, position, and orientation (e.g., body, head, etc.). The sensors 112 may also determine the location, position, velocity, impact levels, and other information of the wireless earpieces 102 as well as the corresponding vehicle 106. The sensors 112 may also receive user input and convert the user input into commands or selections made across the personal devices of the personal area network encompassing the communication system 100. For example, the user input detected by the wireless earpieces 102 may include voice commands, head motions, finger taps, finger swipes, motions or gestures, or other user inputs sensed by the wireless earpieces 102. The user input may be measured by the wireless earpieces 102 and converted into internal commands (utilized by the wireless earpieces 102 themselves) or external commands that may be sent to one or more external devices, such as the vehicle systems 108, a wireless device, a tablet computer, or so forth. For example, the user may create a first specific head motion and first voice command that when detected by the wireless earpieces 102 are utilized to automatically transfer input and output control of communications to the wireless earpieces 102, a first gesture and a second voice command may authorize the wireless earpieces 102 to transfer the input and output control of communications to the vehicle systems 108, a second gesture and a second voice command may authorize the wireless earpieces 102 to play all audio within the vehicle 106 through the wireless earpieces 102. Any number of user biometrics and user input may be utilized alone, or in combination to unlock partitioned data and functionality to effectively sandbox the wireless earpieces 102.

The wireless earpieces may communication with any number of other sensory devices in the communication system 100 to measure information and data about the vehicle 106, vehicle systems 108, and the communication system 100 itself. In one embodiment, the communication system 100 may represent all or a portion of a personal area network. The wireless earpieces 102 may be utilized to control, communicate, manage, or interact with a number of other wearable devices or electronics, such as smart glasses, helmets, smart glass, watches or wrist bands, other wireless earpieces, chest straps, implants, displays, clothing, or so forth. A personal area network is a network for data transmissions among devices, such as personal computing, communications, camera, vehicles, entertainment, and medical devices. The personal area network may utilize any number of wired, wireless, or hybrid configurations and may be stationary or dynamic. For example, the personal area network may utilize wireless network protocols or standards, such as INSTEON, IrDA, Wireless USB, Bluetooth, NFMI, Z-Wave, ZigBee, Wi-Fi, ANT+ or other applicable magnetic or radio frequency signals. In one embodiment, the personal area network may move with the user.

In other embodiments, the communication system 100 may include any number of devices, components, or so forth that may communicate with each other directly or indirectly through a wireless (or wired) connection, signal, or link. The communication system 100 may include one or more networks and network components and devices, such as routers, servers, signal extenders, intelligent network devices, computing devices, or so forth. In one embodiment, a network within the communication system 100 (not shown) represents, a personal area network as previously disclosed. The network 120 may also represent a number of different network types and service providers.

Communications within the communication system 100 may occur through the network 120 or may occur directly between devices, such as the wireless earpieces 102 and the vehicle systems 108 or the wireless device 104, or indirectly through a network, such as a Wi-Fi network. The network may communicate with or include a wireless network, such as a Wi-Fi, cellular (e.g., 3G, 4G, 5G, PCS, GSM, etc.), Bluetooth, or other short range or long range radio frequency network. The network 120 may also include or communicate with any number of hard wired networks, such as local area networks, coaxial networks, fiber-optic networks, network adapters, or so forth. Communications within the communication system 100 may be operated by one or more users, service providers (e.g., secure, public, private, etc.), or network providers.

The wireless earpieces 102 may play, communicate, or utilize any number of alerts, warnings, indicators, or communications to indicate the status of the wireless earpieces 102, vehicle systems 108 as well as the associated connection, communications, privacy, disconnection, and other processes and steps. For example, one or more alerts may indicate when the vehicle systems 108 are in direct communication with the wireless earpieces 102. Other alerts and indicators may be utilized to communicate information, such as oil level, fuel level, seatbelt status of the passengers, vehicle performance (e.g. gas mileage, efficiency, etc.), navigation information, entertainment information, and so forth. The alerts may also indicate whether the user is authorized to communicate utilizing the wireless earpieces 102 and/or the vehicle systems based on biometric readings, user input, and so forth (e.g., passwords, identifiers, combinations of passwords, sequential verification, etc.). The alert may also indicate directions for the vehicle 106, the battery status of the wireless earpieces 102, and various other available information. The corresponding alerts may also be communicated to the user and the wireless device 104.

In other embodiments, the wireless earpieces 102 may also vibrate, flash, play a tone or other sound, or give other indications of the access process status in order to prompt user actions (e.g., giving a sequence of verbal, motion, or audio communications instructions, provide additional feedback, etc.) or implement any number of associated steps. The wireless earpieces 102 may also communicate an alert to the wireless device 104 that shows up as a notification, message, or other indicator indicating the necessity for configuration/re-configuration or a changed status of the configuration process, such as an audio alert that “the vehicle systems are no longer paired with the earpieces.”

The wireless earpieces 102, vehicle system 108, or the wireless device 104 may include logic for automatically implementing communications in the communications system, user requests or various other conditions and factors of the communication system 100. The wireless device 104 may include an application that displays instructions and information to the user for transferring communications between the vehicle systems 108 and the wireless earpieces 102.

In one embodiment, the wireless device 104 may utilize short-range or long-range wireless communications to communicate with the wireless earpieces 102 or vehicle systems 108 through a wireless signal or devices of the communication system 100. For example, the wireless device 104 may include a Bluetooth and cellular transceiver within the embedded logical components. For example, the wireless signal may be a Bluetooth, Wi-Fi, Zigbee, Ant+, near-field magnetic induction (NFMI), or other short range wireless communication.

The wireless device 104 may represent any number of wireless or wired electronic communications or computing devices, such as smart phones, laptops, desktop computers, control systems, tablets, displays, gaming devices, music players, personal digital assistants, vehicle systems, or so forth. The wireless device 104 may communicate utilizing any number of wireless connections, standards, or protocols (e.g., near field communications, NFMI, Bluetooth, Wi-Fi, wireless Ethernet, etc.). For example, the wireless device 104 may be a touch screen cellular phone that communicates with the wireless earpieces 102 and/or vehicle systems 108 utilizing Bluetooth communications. The wireless device 104 may implement and utilize any number of operating systems, kernels, instructions, or applications that may make use of the available sensor data sent from the wireless earpieces 102. For example, the wireless device 104 may represent any number of Android, iOS, Windows, open platforms, or other systems and devices. Similarly, the wireless device 104, vehicles systems, or the wireless earpieces 102 may execute any number of applications that utilize the user input, proximity data, biometric data, and other feedback from the wireless earpieces 102 to initiate, authorize, or perform access associated tasks.

As noted, the layout of the internal components of the wireless earpieces 102 and the limited space available for a product of limited size may affect where the sensors 112 and other components may be positioned. The positions of the sensors 112 within each of the wireless earpieces 102 may vary based on the model, version, and iteration of the wireless earpiece design and manufacturing process.

FIG. 2 further illustrates a block diagram of the wireless earpieces 202 and the vehicle 203. As noted, the components of the wireless earpieces 202 may be described collectively rather than individually. The wireless earpieces 202 may be wirelessly linked to any number of wireless devices, such as the wireless device 104 of FIG. 1. For example, wireless devices may include wearable devices, communications devices, computers, entertainment devices, vehicle systems, exercise equipment, or so forth. Sensor measurements, user input, and commands may be received from either the wireless earpieces 202, the vehicle 203, or the wireless device (not shown) for processing and implementation on any of the devices (or other externally connected devices). Reference to the wireless earpieces 202 may descriptively or functionally refer to either the pair of wireless earpieces (wireless earpieces) together or individual wireless earpieces (left wireless earpiece and right wireless earpiece) without limitation. Description of components of the wireless earpieces 202 also named with regard to the vehicle 203 are similarly applicable. Reference to the vehicle 203 may descriptively and/or functionally refer to any of the vehicle systems, components, subs systems, integrated, or externally carried devices.

In some embodiments, the vehicle 203 and/or wireless device may also act as a logging tool for sensor data or measurements made by the wireless earpieces 202. For example, the wireless device may receive and share data captured by the wireless earpieces 202 in real-time including biometric or location information, such as authentication biometrics or input, status of the user (e.g., physical, emotional, etc.), last known location of the vehicle 203, and so forth. As a result, the vehicle 203 and/or wireless device may be utilized to store, display, and synchronize sensor data received from the wireless earpieces 202. For example, the wireless device may display user pulse rate, temperature, proximity, location, blood oxygenation, distance, calories burned, and so forth as measured by the wireless earpieces 202. The user or a request may also be authenticated by sending the data to the wireless device that may then authenticate the data and authorize a request, function, feature, or so forth. The vehicle 203 and wireless device may be configured to receive and display alerts that indicate conditions to initiate, process, and authenticate communications. For example, if a request is made, the wireless earpieces 202 may automatically display as an alert, message, or in-app communication, such as “please authenticate you have permission to communicate through this vehicle.” The wireless earpieces 202, vehicle 203, and the wireless device may have any number of electrical configurations, shapes, and colors and may include various circuitry, connections, and other components utilized to perform the illustrative embodiments.

In one embodiment, the wireless earpieces 202 may include a battery 208, a logic engine 210, a memory 212, a user interface 214, a physical interface 215, a transceiver 216, and sensors 217. Similarly, the vehicle 203 may have a battery 218, a logic engine 220, a memory 222, a physical interface 224, an entertainment system 224, a navigation systems 225, a transceiver 226, and sensors 227. The wireless device may have any number of configurations and include components and features as are known in the art.

The battery 208 is a power storage device configured to power the wireless earpieces 202. In other embodiments, the battery 208 may represent a fuel cell, thermal electric generator, piezo electric charger, solar charger, ultra-capacitor, or other existing or developing power storage technology. The sensors 217 may also be utilized to measure the temperature of the battery 208 and the conditions and status of internal components of the wireless earpieces 202. The sensors 217 may also be utilized to determine data about internal and external conditions and factors applicable to the user, the user's environment, a communicating wireless device, or so forth. Other conditions and factors sensed by the sensors 217 (e.g., water/humidity, pressure, blood oxygenation, blood content levels, altitude, position, impact, radiation, etc.) may also be determined with the data being processed by the logic engine 210.

The logic engine 210 is the logic that controls the operation and functionality of the wireless earpieces 202. The logic engine 210 may include circuitry, chips, and other digital logic. The logic engine 210 may also include programs, scripts, and instructions that may be implemented to operate the logic engine 210. The logic engine 210 may represent hardware, software, firmware, or any combination thereof. In one embodiment, the logic engine 210 may include one or more processors. The logic engine 210 may also represent an application specific integrated circuit (ASIC) or field programmable gate array (FPGA). The logic engine 210 may utilize sensor measurements, user input, user preferences and settings, conditions, factors, and environmental conditions to determine the identity of the user, at least in part, from measurements performed by the wireless earpieces 202. This information may also be utilized to authenticate the user. The wireless earpieces 202 may function separately or together to authenticate communications, vehicle functionality, and other processes are being performed by an authorized user. For example, processing may be divided between the wireless earpieces 202 to increase the speed of processing and to load balance any processes being performed. For example, a left wireless earpiece may perform imaging of the user's ear to identify the user is authorized to communicate with the vehicle 203 while the right wireless earpiece may identify voice characteristics of the wireless earpieces for transferring a call from the vehicle 203 to the wireless earpieces 202. Multiple forms of identifying information may utilized to better secure requests authenticated through the wireless earpieces 202.

In one embodiment, the logic engine 210 may perform processes, such as the authentication determination based on measurements and data from the sensors 217. The logic engine 210 may also perform any number of mathematical functions (e.g. linear extrapolation, polynomial extrapolation, conic extrapolation, French curve extrapolation, polynomial interpretation) to determine or infer the identity of the user from the sensor 217 measurements as well as determining whether a biometric identifier or password is verifiably received. The logic engine 210 may utilize time and other sensor measurements as causal forces to enhance a mathematical function utilized to perform the determinations, processing, communications, features, and functions performed by the logic engine 210.

The logic engine 210 may also process user input to determine access commands implemented by the wireless earpieces 202 or sent to the wireless earpieces 202 through the transceiver 216. Specific actions may be allowed based on sensor measurements, extrapolated measurements, environmental conditions, proximity thresholds, and so forth. For example, the logic engine 210 may implement an authentication macro allowing the user to automatically transfer communications from the vehicle 203 to the wireless earpieces 202. In another embodiment, different types of actions may require different levels or combinations of biometric and user information. For example, low value data, processes, or actions, such as streaming music, may require a single piece of identifying information (e.g., ear mapping) whereas high value data, such as transferring a phone call from the vehicle 203 to the wireless earpieces 202 may require two pieces of identifying information (e.g., user specified gesture, user sign on to the wireless earpieces 202).

The logic engine 210 is configured to perform all or a substantial portion of the processing needed for the illustrative embodiments. In one embodiment, the logic engine 210 may associate the vehicle 203 with the wireless earpieces 202. For example, the logic engine 210 may associate an identifier (e.g., serial number, custom name, VIN number, etc.) of the vehicle 203 with the wireless earpieces 202 by storing the identifier in the memory 212. The logic engine 210 may also track and record the initial or last known location of the vehicle 203. For example, the wireless earpieces 202 may audibly or tactilely indicated a parking identifier associated with the vehicle 203 or a direction and distance to the vehicle 203 if known or detected in real-time. The vehicle 203 may be tracked directly if within range of the wireless earpieces 202 or indirectly (e.g. cellular signals, satellite signals, network signals, other users/mesh network nodes, etc.) based on available signals, networks, or information. The logic engine 210 may also facilitate the user in searching for, locating, and navigating to the vehicle 203. In one embodiment, the logic engine 210 may execute a mapping application that facilitates the user in driving, walking, writing, or otherwise navigating to the location of the vehicle 203. For example, the logic engine 210 may provide instructions or commands through the user interface 214 including a speaker, vibrator, or other interface components to navigate to the vehicle 203. Instructions provided to the user through the speaker of the user interface 214 may be particularly secure because outside parties are not able to easily intercept or listen in to the audio feedback. In some situations, the user may transition from communications through the vehicle 203 to the wireless earpieces 202 for enhanced security and privacy.

In another embodiment, the logic 210 may send a message to the vehicle 203 from the transceiver 216 to the transceiver 226 to play a sound, light up, vibrate, or otherwise communicate with the user a corresponding alert, indicator, message, or other communication. The physical interface 224 of the vehicle 203 may include user interface and physical interface components as described with respect to the wireless earpieces 202.

In one embodiment, a processor included in the logic engine 210 is circuitry or logic enabled to control execution of a set of instructions. The processor may be one or more microprocessors, digital signal processors, field-programmable gate arrays, application-specific integrated circuits (ASIC), central processing units, or other devices suitable for controlling an electronic device including one or more hardware and software elements, executing software, instructions, programs, and applications, converting and processing signals and information, and performing other related tasks.

The memory 212 is a hardware element, device, or recording media configured to store data or instructions for subsequent retrieval or access at a later time. The memory 212 may represent static or dynamic memory. The memory 212 may include a hard disk, random access memory, cache, removable media drive, mass storage, or configuration suitable as storage for data, instructions, and information. In one embodiment, the memory 212 and the logic engine 210 may be integrated. The memory may use any type of volatile or non-volatile storage techniques and mediums. The memory 212 may store information related to the user, wireless earpieces 202, vehicle 203, and other peripherals, such as a wireless device, smart glasses, smart watch, smart case for the wireless earpieces 202, wearable device, and so forth. In one embodiment, the memory 212 may store, display, or communicate instructions, programs, drivers, or an operating system for controlling the user interface 214 including one or more LEDs or other light emitting components, speakers, tactile generators (e.g., vibrator), and so forth. The memory 212 may also store biometric readings, user input (e.g., gestures, voice commands, swipes or taps, etc.) required for specified data, functions, or features, authentication settings and preferences, thresholds, conditions, signal or processing activity, historical information, proximity data, and so forth. The memory 212 may also store instructions, applications, or so forth for communicating with or tracking the vehicle 203.

The transceiver 216 is a component comprising both a transmitter and receiver which may be combined and share common circuitry on a single housing. The transceiver 216 may communicate utilizing NFMI, Bluetooth, Wi-Fi, ZigBee, Anti+, near field communications, wireless USB, infrared, mobile body area networks, ultra-wideband communications, cellular (e.g., 3G, 4G, 5G, PCS, GSM, etc.), infrared, or other suitable radio frequency standards, networks, protocols, or communications. For example, the transceiver 216 may coordinate communications and actions between the wireless earpieces 202 utilizing NFMI communications. The transceiver 216 may also be a hybrid transceiver or dual transceiver that supports a number of different communications. For example, the transceiver 216 may communicate with the vehicle 203, wireless devices, or other systems utilizing wired interfaces (e.g., wires, traces, etc.), NFC, Wi-Fi, or Bluetooth communications. The transceiver 216 may also detect amplitudes and infer distance between the wireless earpieces 202 and the vehicle 203 or other external devices, such as the wireless device or a smart case of the wireless earpieces 202.

In one embodiment, the transceiver 216 may be configured to determine proximity or a location of the vehicle 203 utilizing signal strength, wireless triangulation, or directional feedback. For example, the transceiver 216 may include one or more antennas that facilitate detecting the amplitude, communicated direction of signals received, and so forth. In one embodiment, the wireless earpieces 202 may work as separate receivers to determine a distance, orientation, or location of the vehicle 203. For example, when worn, the wireless earpieces 202 ma be separated by a known distance associated with the user's head. The distance between the wireless earpieces 202 as well as the time stamp associated with when a signal was received may be utilized to determine a direction and/or location to the vehicle 203. Similarly, any number of tables, distances, thresholds, database entries, or historical information may be utilized to determine a distance and direction between the wireless earpieces 202 and the vehicle 203 in a particular environment.

In one embodiment, the wireless earpieces 202 may also utilize the sensors 217 and other features of the wireless earpieces 202 detect emergency events, such as racks, heart events of the user, or other medical trauma or problems. For example, as noted the wireless earpieces 202 may be configured to detect impacts, pulse rate of the user when the wireless earpieces 202 are worn in the ears of the user, blood pressure, and other important user biometrics. In response to the wireless earpieces 202 detecting an emergency event, the wireless earpieces may automatically activate an emergency communication through the vehicle 203, and associated wireless device, or the wireless earpieces 202 themselves.

The components of the wireless earpieces 202 may be electrically connected utilizing any number of wires, contact points, leads, busses, wireless interfaces, or so forth. In addition, the wireless earpieces 202 may include any number of computing and communications components, devices or elements which may include busses, motherboards, circuits, chips, sensors, ports, interfaces, cards, converters, adapters, connections, transceivers, displays, antennas, and other similar components. The physical interface 215 is hardware interface of the wireless earpieces 202 for connecting and communicating with wireless devices, the vehicles, or other electrical components, devices, or systems.

The physical interface 215 may include any number of pins, arms, or connectors for electrically interfacing with the contacts or other interface components of external devices or other charging or synchronization devices. For example, the physical interface 215 may be a micro USE port. In one embodiment, the physical interface 215 is a magnetic interface that automatically couples to contacts or an interface of a vehicle or wireless device. In another embodiment, the physical interface 215 may include a wireless inductor for charging the wireless earpieces 202 without a physical connection to a charging device.

The user interface 214 is a hardware and software interface for receiving commands, instructions, or input through the touch (haptics) of the user, voice commands, or predefined motions. For example, the user interface 214 may include a touch screen, one or more cameras or image sensors, microphones, speakers, and so forth. The user interface 214 may be utilized to control the other functions of the wireless earpieces 202. The user interface 214 may include the LED array, one or more touch sensitive buttons or portions, a miniature screen or display, or other input/output components. The user interface 214 may be controlled by the user or based on commands received from the wireless device. For example, the user may turn on, reactivate, implement searches, or provide feedback utilizing the user interface 214. The user interface 214 may include an audible menu, alerts, and indicators that provide information to the user. For example, explicit audio prompts may be utilized to navigate features and functions of the wireless earpieces 202. Similarly, indicators, such as sound icons, may be utilized to indicate when a feature such as audio transparency (external audio and sounds being passed through to the user) is activated or deactivated.

In one embodiment, the user interface 214 may include a fingerprint scanner that may be utilized to scan a fingerprint (e.g., the index finger) of a user to authenticate a user, request, functionality, or so forth. The user interface 214 of each of the wireless earpieces 202 may store identifying information for one or more fingers. In one embodiment, the biometric data of the user may be encrypted and stored within a secure portion of the memory 212 to prevent unwanted access or hacking. The wireless earpieces 202 may also store important biometric data, such as medical information (e.g., medical conditions, allergies, logged biometrics, contacts, etc.) that may be shared in response to an emergency.

In one embodiment, the user may provide user feedback for authenticating a communication request by tapping the user interface 214 once, twice, three times, or any number of times (e.g., sequentially or in a timed pattern). Similarly, a swiping motion may be utilized across or in front of the user interface 214 (e.g., the exterior surface of the wireless earpieces 202) to implement a predefined action, such as transferring a call to the wireless earpieces from the communication/entertainment system 224 of the vehicle 203. Swiping motions in any number of directions or gestures may be associated with specific requests as well as other activities, such as transfer a call back to the vehicle 203, share pulse data, receive a voice command, enable a dictation feature, open a specified app, play music, pause, fast forward, rewind, activate a digital assistant (e.g., Siri, Cortana, smart assistant, etc.), or so forth without limitation. The swiping motions and gestures may also be utilized to control actions and functionality of vehicle sub-systems, wireless devices, or other external devices (e.g., smart television, camera array, smart watch, etc.) through wireless signals sent by the transceiver 216. The user may also provide user input for authorizing an action or request by moving his head in a particular direction or motion or based on the user's position or location. For example, the user may utilize voice commands, head gestures, or touch commands to change the content displayed by the navigation system 225 of the vehicle 203. For example, a user may provide a verbal command to “provide driving directions to work from here.” The speaker of the user interface 214 of the wireless earpieces 202 may then provide audible instructions and indicators which may include direction, heading, suggested speed, obstacles in the path, suggestions, or so forth. The user interface 214 may also provide a software interface including any number of icons, soft buttons, windows, links, graphical display elements, and so forth for receiving user input. The features available to the user may be more comprehensive if the user is determined to be a passenger in the vehicle 203 instead of the driver. For example, distinct entertainment options may be available to passengers of the vehicle 203 utilizing wireless earpieces.

In one embodiment, the user interface 214 may periodically utilize one or more microphones and speakers of the wireless earpieces to authenticate the user. The microphone of the user interface 214 may measure various voice characteristics including amplitude, shimmer rates (i.e., changes in amplitude over time) frequency/pitch, jitter rate (i.e., changes in frequency data over time), accent, voice speed, inflection, and so forth. Specific words, phrases, or sounds may be associated with actions as stored in the memory 212 and detected by one or more microphones of the user interface 214. The microphones may include external microphones positioned on the outside surface(s) of the wireless earpieces 202 (e.g., air microphones) as well as internal microphones (e.g., bone, ear-bone microphones, etc.). The wireless earpieces 202 may also recognize a pre-defined vocabulary. For example, specific words may be required to authenticate different requests and action types.

The sensors 217 may include inertial sensors, pulse oximeters, accelerometers, gyroscopes, magnetometers, water, moisture, or humidity detectors, impact/force detectors, thermometers, photo detectors, miniature cameras, microphones, and other similar instruments for identifying the user and reading biometrics as well as location, utilization of the wireless earpieces 202, orientation, motion, and so forth. The sensors 217 may also be utilized to determine, the biometric, activity, location, and speed measurements of the user. In one embodiment, the sensors 217 may store data that may be shared with other components (e.g., logic engine 210 authenticating a search request), users, and devices. As previously noted, the sensors 217 may be utilized to detect emergency situations or conditions of the user. For example, the sensors 217 may detect if the user is in an accident if the vehicle 203 (and corresponding systems) are catastrophically damaged. Similarly, the sensors 217 may warn the user if the user's heart rate, respiration rate, or head orientation or nodding is indicative of the user falling asleep to generate alerts to stop driving, change drivers, or activate other stimuli. The wireless earpieces 202 may also provide additional c information, indicators, or warnings based on biometric data of the user as well as the environment of the vehicle.

The sensors 217 may include photodetectors, ultrasonic mapping devices, or radar that scan the ear of the user when positioned for utilization. The sensors 217 may generate a two or three dimensional scan or topography map of the user's ear and surrounding areas when the wireless earpieces 202 are properly positioned. The mapping may include the internal and/or external portions of the user's ear. The topographical image of the user's ear may be utilized as a stand-alone biometric identifier or may be utilized with other biometric identifiers to identify the user. The image may include the external auditory meatus, scapha, fossa triangularis, scaphoid fossa, helix, antihelix, antitragus, lobule, the tragus, and pinna as well as other internal or external portions of the ear and surrounding head structure.

Externally connected wireless devices as well as the vehicle 203 may include components similar in structure and functionality to those shown for the wireless earpieces 202. For example, a wireless device may include any number of processors, batteries, memories, busses, motherboards, chips, transceivers, peripherals, sensors, displays, cards, ports, adapters, interconnects, sensors, and so forth. In one embodiment, the wireless device may include one or more processors and memories for storing instructions. The instructions may be executed as part of an operating system, application, browser, or so forth to implement the features herein described. For example, the user may set preferences for the wireless earpieces 202 to work individually or jointly to identify user biometrics for comparison against known values to verify the user is authorized to communicate with the vehicle 203. Likewise, the preferences may manage the actions taken by the wireless earpieces 202 in response to identifying specific users are utilizing the wireless earpieces 202. For example, a parent user may have full access to communicate through the vehicle 203, but a juvenile user may only have access to receive navigation data through the wireless earpieces 202. In one embodiment, the wireless earpieces 202 may be magnetically or physically coupled to the physical interface 224 of the vehicle 203 or a wireless device to be recharged or synchronized.

The vehicle 203 or a wireless device may also execute applications with settings or conditions for updating, synchronizing, communicating, sharing, saving, processing requests and utilizing biometric information. For example, one of the sensors 217 that may have failed may be ignored in response to improper or unreliable data being gathered. As a result, the user identification process for performing authorizations may be dynamically performed utilizing any combination of sensor measurements. For example, the number and position of the sensors 217 utilized to gather biometric data of the user may vary based on failures, inaccurate data, or other temporary or permanent issues with hardware and software of the wireless earpieces 202.

In one embodiment, the vehicle 203 may include all or a portion of the components shown in FIG. 2 with regard to the wireless earpieces 202. In one embodiment, the vehicle 203 includes a battery 218 to facilitate in part communications with other devices, such as the wireless earpieces 202, utilizing the transceiver 226. In another embodiment, the vehicle 203 may be powered by fuel cells, solar cells, a gasoline motor, or so forth. The vehicle 203 may utilize any number of propulsion engines or methods (e.g., gasoline, natural gas, batteries, solar cells, fuel cells, combustibles, etc.). passively powered utilizing induction based on radio frequency waves, wireless signals, or so forth.

The logic engine 220 may also represent a processor or fixed digital logic that controls and manages processing of information, software, signals, functionality, and other processes, systems, and components of the vehicle 203. For example, the logic engine 220 may represent a chip set configured to implement specified processes, modules, and instructions in response to signals from the wireless earpieces 202 or in response to other conditions, settings, or preferences.

The memory 222 may store identification, communication, threshold, and alert information. For example, specified biometric information, user input, or other secure identifiers may be required to be received by the transceiver 226 of the vehicle 203 and verified by the logic engine 220 against data, values, or information stored by the memory 222 in order for the systems of the vehicle 203 to implement communications, features, functions, or other processes.

The physical interface 224 may allow the vehicle 203 to be physically, magnetically, or electrically coupled with any number of other devices, such as the wireless earpieces 202, a smart case of the wireless earpieces 202, a cell phone link to the wireless earpieces 202, or other electronic devices. In another embodiment, the physical interface 224 may also include user interface components similar to those described for the wireless earpieces 202. For example, the physical interface 224 may include one or more touchscreens or texts sensitive components, light emitting diodes, speakers, microphones, or so forth. For example, the physical interface 224 may include a USB port for connecting to the smart case with the wireless earpieces 202 inside for charging, synchronization, and so forth.

The communication/entertainment system 225 is a communication and entertainment system that may include functionality for processing communications, such as phone calls, text messages, application communications, and so forth. The transceiver 226 may send and receive communications from any number of devices or networks for communication or display through the communication/entertainment system 225. The communication/entertainment system 225 may represent one, two, or more systems. In one, the communication/entertainment system 225 may also receive any number of audio, video, or other communications. The communication/entertainment system 225 may also be configured to play DVDs, CDs, USB drives, audio files, video files, or other content received by the communication/entertainment system 225 digitally or physically.

The navigation system 228 may include one or more location detection devices, such as a global positioning system, wireless triangulation unit, signal strength and direction detector, or so forth. In one embodiment, the navigation system 228 may determine a location of the vehicle 203. The location may be determined utilizing latitude and longitude, location relevant to a mapping database, or location and/or distances relative to the wireless earpieces 202 or an associated wireless device. The navigation system 228 may be configured to determine the exact location, known landmark(s) (e.g., roads, parks, homes, businesses, etc.), or an identified user (e.g., the user/device may represent a known node in a mesh network). The navigation system 228 may be controlled by the logic engine 222 to send location and identification information to other electronic devices, such as the wireless earpieces 202, utilizing the transceiver 226. The navigation system 228 may also communicate instructions, feedback, or commands through the transceiver 226 that may be received by the transceiver 216, and converted by the logic engine 210 into verbal or audible instructions, feedback, or commands for the user to find the vehicle 203. The wireless earpieces 202 may filter, mute, or otherwise limit communications from navigation system, such that the communications (e.g., phone calls, video communications, etc.) are not communicated or bled through to other communications.

As noted, the vehicle 203 may also include the sensors 227. The sensors 227 may detect the orientation, environment, internal characteristics, or other conditions and factors that may affect the vehicle 203 as previously described with regard to the sensors 217 of the wireless earpieces 202. The sensors 227 may also provide information (e.g., temperature, pressure, settings, performance efficiency, status, etc.) regarding the engine/motor, transmission tires, electrical system, heating/cooling systems, climate control systems, internal/external temperatures, batteries, fuel system, and other components and sub-systems of the vehicle.

The transceiver 226 may include one or more of a transmitters and/or receivers. The transceiver 226 may be configured to communicate directly or indirectly with one or more wireless earpieces 202, wireless devices, other vehicles, satellite devices, or wireless network equipment, systems, or devices. As previously noted, any number of communications standards, protocols, or signals may be utilized.

The user interface 230 may include input/output devices for communicating with the user. In one embodiment, the user interface 230 may include one or more touch screens, buttons, switches, dials, ports, speakers, microphones, displays, light emitting diodes, and so forth. The user interface 230 may receive information and selections from the user and display or otherwise communicate applicable information, data, and so forth applicable to the vehicle 203, the wireless earpieces 202, the user, or devices or equipment integrated within or carried by the vehicle 203. In one embodiment, the user may provide feedback to switch back and forth between utilizing the wireless earpieces 202 for communications utilizing input provided through the user interface 230.

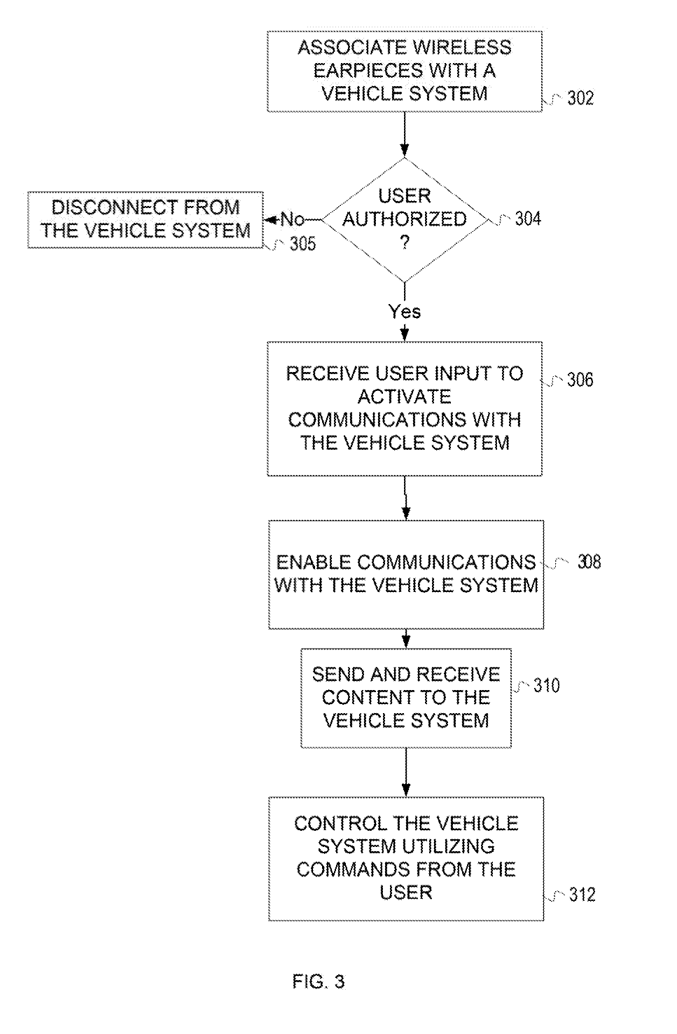

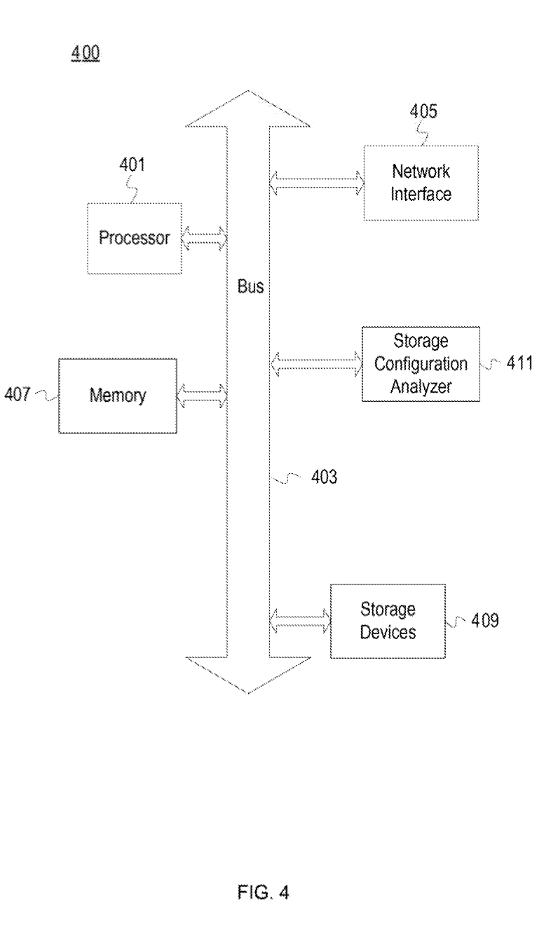

FIG. 3 is a flowchart of a process for performing communications with a vehicle system utilizing wireless earpieces in accordance with an illustrative embodiment. In one embodiment, the process of FIG. 4 may be implemented by one or more wireless earpieces, a wireless device, and a vehicle system, such as the wireless earpieces 102, e wireless device 104, and the vehicle system 108 of FIG. 1. References to the vehicle system and the wireless earpieces may include the wireless device that is paired or otherwise associated with the vehicle system to facilitate and enhance communications of the vehicle. For example, the method of FIG. 4 may be performed for both of the wireless earpieces as a pair/set or for each of wireless earpieces individually to communicate with the vehicle system. As previously noted, the vehicle system may represent any number of entertainment, navigational, control, and information systems of a vehicle.

The method of FIG. 3 may begin by associating wireless earpieces with a vehicle system (step 302). The vehicle system may be associated with the wireless earpieces utilizing any number of processes or steps. For example, the wireless earpieces may be placed in close proximity to the vehicle system or vice versa, the wireless earpieces may be physically connected to the vehicle system, or wirelessly interfaced with the wireless earpieces (e.g. Bluetooth linking, password or pin verification, etc.). In one embodiment, the vehicle system and the wireless earpieces may be linked by a Bluetooth connection.

Next, the wireless earpieces determine whether the user is authorized (step 304). In one embodiment to perform any communications with the vehicle system, the wireless earpieces may require biometric readings or user input to authenticate or identify the user and that the user is authorized to communicate with the vehicle system. In one embodiment, the biometric readings and user input may include one or more of pulse, hand gestures, designated motions, voice amplitude, voice frequency, skin conductivity, vocabulary, blood oxygenation, temperature, heart beat pattern, ear map, calories expended per time period, sweat levels, orientation, position, and other user identifying information. The authentication, identification, or authorization of step 304 may be performed automatically or manually. For example, the wireless earpieces may automatically identify the user in response to the wireless earpieces being worn, being within range of the vehicle system, or any number of other criteria, factors, or conditions.

The sensor locations and types of sensors within the wireless earpieces may vary. The sensors may generate a number of biometric readings that may be utilized individually or compiled to subsequently identify the user and specific biometric factors. The sensors may include one or more inertial sensors, temperature sensors, heart pulse rate sensors, skin conductivity sensors, and microphones (i.e., analyzing the user's voice). The sensors may measure data or information that may be utilized to determine or imply the user's identity as herein described.

The sensor may utilize any number of sampling rates or time periods for performing the sensor measurements. For example, the sensors may identify the user from the moment the wireless earpieces or placed in the ears of the user such that any communications requests with the vehicle may be automatically authenticated as belonging to the authorized user. The biometric readings may also be performed in response to receiving a user request to connect to the vehicle system. For example, the wireless earpieces may store user preferences and access information that specify the type, order, and accuracy of biometric information and user input required to perform authentication.

The wireless earpieces may also analyze the biometric readings to determine whether the wireless earpieces are authorized to communicate with the vehicle system. The biometric readings or other user input may be analyzed for accuracy statistical significance, and so forth. For example, the biometric readings may be compared against default, baseline, or standard biometric readings for the user to ensure accuracy in identifying the user or required identifier. Likewise, user input that may be received for verification purposes may be compared against pre-established or trained data. The wireless earpieces may also perform biasing or error correction as needed to ensure the sensor measurements are accurate. For example, if a sensor from one of the wireless earpieces is experience incorrect of inaccurate data, the data from that sensor may be disregarded for purposes of performing analysis. The sensor measurements may be run through any number of computations utilizing the processor of one of the wireless earpieces. In one embodiment, a number of biometric readings and/or user input may be required to be received sequentially, simultaneously, or concurrently. The identity of the user may be determined utilizing the biometric readings. In one embodiment, a number of different users may utilize the wireless earpieces at any given time. For example, each of the different users may have distinct vehicle profiles, personal information, security settings, permissions, applications and preferences that may be utilized by the user. The wireless earpieces may ensure that all security measures, conditions, thresholds, and information are provided and authenticated to perform the communicating process.

If the user is not authorized during step 304, the wireless earpieces disconnect from the vehicle system (step 305). During step 304, the wireless earpieces may also prevent connection to or pairing with the vehicle system in response to determining the user and/or wireless earpieces are not authorized to communicate with the vehicle system.

Next, the wireless earpieces receive user input to activate communications with the vehicle system (step 306). In one embodiment, the communications may be directly with the vehicle system or a wireless device. In other embodiments, the vehicle system may control communications features performed by the wireless device. The user input may represent a head motion, gesture, tap, or other input. For example, the user may nod her head to implement Bluetooth communications between the wireless earpieces and the vehicle system. The accelerometers or other sensors may detect the head motion. In another example, the user may tap one of the wireless earpieces to enable navigation information to be communicated to the wireless earpieces. A touch sensor of the wireless earpieces may detect the touch of the user's finger. The activation of communications may

During step 306, the wireless earpieces may disconnect from other connected devices or where allowed may simultaneously connect to multiple devices. For example, different connection types may be enabled between distinct electronic devices.

Next, the wireless earpieces enable communications with the vehicle system (step 308). The communications may include phone or video calls, discrete messages (e.g., text messages, video messages, audio messages, pictures, etc.), control of vehicle systems or features, or so forth.

Next, the wireless earpieces send and receive content to the vehicle system (step 310). Audio content may be communicated to the wireless earpieces in real time, in queued messages, or as otherwise received. In one embodiment, the communications may be encrypted or otherwise protected when sent between the wireless earpieces and the vehicle system. Audio content may also be recorded by the wireless earpieces for communication to the vehicle system. For example, audio that is part of a phone call may be received through your bone and external microphones of the wireless earpieces. The wireless earpieces may actively filter out navigation information, external noise, or conversations that are not received from the user. In one example, the wireless earpieces may enable the user to receive navigation information and instructions while preventing those same instructions from being heard through a phone call the user is participating in utilizing the wireless earpieces and the vehicle system. The wireless earpieces may filter out sounds, text, alerts, instructions, or other extraneous noise that the user does not want to communicate as part of a real-time phone call or other communication. As a result, parties talking with the user do not need to know that the user is driving or in the vehicle. Direct communications from the wireless earpieces (sending and receiving) provide for more secure communications with enhanced privacy for the user. As a result, passengers in the vehicle do not need to be privy to the full conversation being had by the user.

Next, the wireless earpieces control the vehicle system utilizing commands from the user (step 312). The wireless earpieces may control the vehicle before, during, or after communications as provided in FIG. 3. For example, any number of specific commands, keywords, motions, gestures, or other user input may be received by the user to control specific vehicle systems and features. For example, a double tap of the wireless earpieces may configure the navigation system to navigate to the home of the user, an upward swipe of the right wireless earpiece may rollup all of the windows in the vehicle, tilting the user's head to the right may turn down the audio system of the vehicle that may be playing music or a video to the other passengers to facilitate effective communications through the wireless earpieces. Step 312 may be performed as an independent step initiated whenever feedback is received from the user.

During the steps of FIG. 3 any number of alerts may be generated indicating the status of the association, communications, and so forth. For example, the alerts may be communicated to the user as an audio, tactile, or visual alert, such as “the wireless earpieces are ready to communicate with the vehicle.” The alert may also be communicated to a wireless device in communication with the wireless earpiece. For example, an alert may be sent to a cell phone in communication with the wireless earpiece to display an application specific alert to the user, such as “the user is in privacy mode for this phone call.” In some embodiments, the alert may be sent through email, text message, vehicle alert (e.g., infotainment system), or other designated communications technique, step, or method. The process of FIG. 3 may allow the wireless earpieces to utilize logic to associate, receive user input, enable communications, sent and receive content, and control vehicle systems.

The illustrative embodiments provide a system, method, and wireless earpiece(s) for gestured based toggle controls for communications with a wireless device, wireless earpieces, and a vehicle. The illustrative embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments of the inventive subject matter may take the form of a computer program product embodied in any tangible medium of expression having computer usable program code embodied in the medium. The described embodiments may be provided as a computer program product, or software, that may include a machine-readable medium having stored thereon instructions, which may be used to program a computing system (or other electronic device(s)) to perform a process according to embodiments, whether presently described or not, since every conceivable variation is not enumerated herein. A machine readable medium includes any mechanism for storing or transmitting information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read only memory (ROM); random access memory (RAM); erasable programmable memory (e.g., EPROM and EEPROM); flash memory; or other types of medium suitable for storing electronic instructions. In addition, embodiments may be embodied in an electrical, optical, acoustical or other form of propagated signal (e.g., carrier waves, infrared signals, digital signals, etc.), or wireline, wireless, or other communications medium.

Computer program code for carrying out operations of the embodiments may be written in any combination of one or more programming languages, including an object oriented programming language such as Java, Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer or entirety on the remote computer or server. In the latter scenario, the remote computer may be connected to the user's computer through any type of network, including a local area network (LAN), a personal area network (PAN), or a wide area network (WAN), or the connection may be made to an external computer (e.g., through the Internet using an Internet Service Provider).

FIG. 5 depicts a computing system 500 in accordance with an illustrative embodiment. For example, the computing system 500 may represent a computing or communications device, such as the vehicle system 108 or the wireless device 104 of FIG. 1. The computing device 500 may be utilized to coordinate and manage communications with the wireless earpieces herein described. The computing system 500 includes a processor unit 501 (possibly including multiple processors, multiple cores, multiple nodes, and/or implementing multi-threading, etc.). The computing system includes memory 507. The memory 507 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The computing system also includes a bus 503 (e.g., PCI, ISA, PCI-Express, HyperTransport®, InfiniBand®, NuBus, etc.), a network interface 505 (e.g., an ATM interface, an Ethernet interface, a Frame Relay interface, SONET interface, wireless interface, etc.), and a storage device(s) 509 (e.g., optical storage, magnetic storage, etc.). The system memory 507 embodies functionality to implement embodiments described above. The system memory 507 may include one or more functionalities that facilitate retrieval of the audio information associated with an identifier. Code may be implemented in any of the other devices of the computing system 500. Any one of these functionalities may be partially (or entirely) in hardware and/or on the processing unit 501. For example, the functionality may be implemented with an application specific integrated circuit, in logic implemented in the processing unit 501, in a co-processor on a peripheral device or card, etc. Further, realizations may include fewer or additional components not illustrated in FIG. 5 (e.g., video cards, audio cards, additional network interfaces, peripheral devices, etc.). The processor unit 501, the storage device(s) 509, and the network interface 505 are coupled to the bus 503. Although illustrated as being coupled to the bus 503, the memory 507 may be coupled to the processor unit 501.

The illustrative embodiments are not to be limited to the particular embodiments described herein. In particular, the illustrative embodiments contemplate numerous variations in the type of ways in which embodiments may be applied. The foregoing description has been presented for purposes of illustration and description. It is not intended to be an exhaustive list or limit any of the disclosure to the precise forms disclosed. It is contemplated that other alternatives or exemplary aspects are considered included in the disclosure. The description is merely examples of embodiments, processes or methods of the invention. It is understood that any other modifications, substitutions, and/or additions may be made, which are within the intended spirit and scope of the disclosure. For the foregoing, it can be seen that the disclosure accomplishes at least all of the intended objectives.

The previous detailed description is of a small number of embodiments for implementing the invention and is not intended to be limiting in scope. The following claims set forth a number of the embodiments of the invention disclosed with greater particularity.

What is claimed is:

1. A method for communicating with a vehicle system, the method comprising:
associating the vehicle system with one or more wireless earpieces;
determining whether a user is authorized to communicate with the vehicle system utilizing the one or more wireless earpieces by performing biometric readings for the user utilizing sensors of the one or more wireless earpieces, wherein the determination whether the user is authorized to communicate with the vehicle system is performed utilizing the biometric readings;
receiving user input to activate communications with the vehicle system through the one or more wireless earpieces;
enabling communications between the one or more wireless earpieces and the vehicle system;
sending and receiving the communications between the one or more wireless earpieces and the vehicle system; and
controlling the vehicle system utilizing user input received from the user through the one or more wireless earpieces and sent as a part of the communications between the one or more wireless earpieces and the vehicle system.

2. The method of claim 1, wherein the user input is a gesture performed by a head of the user.

3. The method of claim 2 wherein an inertial sensor of the one or more wireless earpieces detects the gesture performed by the head of the user.

4. The method of claim 1, comprising:
terminating active communications between the vehicle system and the one or more wireless earpieces in response to an additional user input.

5. The method of claim 1, further comprising:
disconnecting from the vehicle system in response to determining the user is not authorized to communicate with the vehicle system utilizing, the one or more wireless earpieces.

6. The method of claim 1, wherein the biometric readings include two or more of voice characteristics, pulse, ear mapping, or temperature.

7. The method of claim 1, wherein the one or more wireless earpieces are a pair of wireless earpieces worn in ears of the user.

8. The method of claim 1, wherein the one or more wireless earpieces communicate with the vehicle system utilizing a Bluetooth connection.

9. The method of claim 1, wherein the biometric readings are automatically read by the wireless earpieces in response to the one or more wireless earpieces being worn by the user.

10. The method of claim 1, wherein the user input is specified by the user for enabling the communications between the one or more wireless earpieces and the vehicle system.

11. A wireless earpiece comprising:
a processor for executing a set of instructions; and
a memory for storing the set of instructions, wherein the set of instructions are executed to:
associate a vehicle system with the wireless earpiece;
determine whether a user is authorized to communicate with the vehicle system utilizing die wireless earpiece;
receive user input to activate communications with the vehicle system through the wireless earpiece;
enable communications between the wireless earpiece and the vehicle system; and
sending and receiving the communications between the wireless earpiece and the vehicle system.

12. The wireless earpiece of claim 11, wherein the set of instructions are further executed to:
perform biometric readings for the user utilizing sensors of the wireless earpiece, wherein the determination whether the user is authorized to communicate with the vehicle system is performed utilizing the biometric readings

13. The wireless earpiece of claim 11, wherein the set of instructions are further executed to:
control the vehicle system utilizing user input received from the user through the wireless earpiece.

14. The wireless earpiece of claim 12, wherein the set of instructions are further executed to:
terminate active communications between the vehicle system and the wireless earpiece in response to an additional user input.

15. The wireless earpiece of claim 13, wherein the user input is specified by the user for enabling the communications between the wireless earpiece and the vehicle system.

16. A wireless earpiece, comprising:
a frame for fitting in an ear of a user;
a logic engine controlling functionality of the wireless earpiece;
a plurality of sensors perform biometric readings of the user and receiving user inputs, wherein a user wearing the wireless earpiece is authenticated utilizing one or more biometric readings or user inputs received from the user,
wherein the logic engine:
associates a vehicle system with the wireless earpiece;
determines whether a user is authorized to communicate with the vehicle system the wireless earpiece;
receives user input to activate communications with the vehicle system through the wireless earpiece;
enables communications between the wireless earpiece and the vehicle system; and
sends and receives the communications between the wireless earpiece and the vehicle system utilizing a transceiver in communication with the logic.

17. The wireless earpiece of claim 16, wherein the user pre-established a plurality of commands with each of a plurality of actions detectable by the wireless earpiece.

18. The wireless earpiece of claim 16, wherein the wireless earpiece is one of a pair of wireless earpieces worn in-ear, and wherein the wireless earpiece communicates with the vehicle system utilizing a Bluetooth connection.

19. The wireless earpiece of claim 16, wherein the biometric readings include one or more of voice characteristics and topographical mapping of an ear of the user.
